(19) United States
(12) Patent Application Publication
(10) Pub. No.: US 2026/0230657 A1
(43) Pub. Date: Aug. 6, 2026

(54) SYSTEM, METHOD AND APPARATUS FOR AUTOMATIC VIDEO SELECTION AND PRESENTATION

(71) Applicant: LiveWired, LLC, Carlsbad, CA (US)

(72) Inventors: Mark Baldi, Rancho Santa Fe, CA (US); Michael Lamb, Rancho Santa Fe, CA (US); Brett Worthington, Thousand Oaks, CA (US)

(21) Appl. No.: 19/045,782

(22) Filed: Feb. 5, 2025

(51) Int. Cl. H04N 21/2187; H04N 21/25; H04N 21/442

(52) U.S. Cl. CPC H04N 21/2187; H04N 21/251; H04N 21/44204

(57) ABSTRACT

A system, method and apparatus are described for automatically selecting and presenting livestream videos to online viewers. A video production server receives a plurality of livestream videos from spectators at a live event, determines one or more attributes and tabulates the attributes of each livestream video. The livestream videos are provided in real-time to online viewers who previously requested to receive livestream videos of the live event. The video production server may receive a request from at least some of the online viewers of the event to automatically select and provide livestream videos based on one or more attributes of the livestream videos. The video production server may then automatically select one of the livestream videos for presentation to the online users who requested automatic livestream video selection and presentation.

### BACKGROUND

### I. Field of Use

The present application relates to the field of online entertainment. More specifically, the present application relates to improving multi-view, online video presentations by automatically selecting and presenting livestream videos to online viewers.

### II. Description of the Related Art

In recent years, people have been using their mobile electronic devices, such as mobile phones, to record and livestream live events, such as concerts, sporting events, etc. Online services exist today that allow users to capture such events via their mobile devices and allow others to watch the event, sometimes live, from a variety livestream videos provided by different event spectators. Viewers of the livestream videos are typically provided with a user interface that allows viewers to select which of a plurality of livestream videos to watch to view the event, typically from a plurality of thumbnail photos or videos representing the plurality of livestream videos available for viewing. However, there are several disadvantages of allowing viewers to select various videos.

A first disadvantage is that it can be tedious for viewers to continuously evaluate videos of an event to choose which ones to view. Additionally, viewers may miss desired portions of an event if they happen to choose particular videos that have not recorded an interesting or desirable portion of an event. Yet another disadvantage is that a user's general video-watching preferences cannot be taken into account—viewers must constantly evaluate videos that suit their taste.

Current video-on-demand technology is not well-suited to deliver custom-selected videos to viewers, as oftentimes the videos are livestream videos which occur in real-time and may last only a few seconds. Moreover, present video-on-demand technology does not allow for feedback from viewers, which could aid a video production server to deliver content more suited to each viewer.

It would be advantageous to improve such multi-view, online video-on-demand technology to make videos easier for viewers to enjoy.

### SUMMARY

The embodiments described herein relate to a system, method and apparatus for automatically selecting and presenting livestream videos to online viewers. In one embodiment, a method is described,, performed by a video production server, comprising receiving a plurality of livestream videos from a plurality of spectators at an event, presenting the plurality of livestream videos to the online viewers simultaneously, allowing the online viewers to manually select which livestream videos they would like to view, receiving an indication from each of the online viewers each time that one of the plurality of livestream videos is selected for viewing by an online viewer, tabulating metadata associated with each indication, selecting a first livestream video from the plurality of livestream videos currently being viewed by the online viewers based on the tabulated metadata, receiving a request from a first online viewer to automatically present livestream videos of the event, and causing the first video to be presented to the first online viewer on a main viewing window of a first content consumption device associated with the first online viewer.

In another embodiment, a video production server is described, for automatically selecting and presenting livestream videos to online viewers, comprising a communication interface, a non-transitory memory for storing processor-executable instructions, and a processor, coupled to the communication interface and the memory for executing the processor-executable instructions that causes the video production server to receive, by the processor via the communication interface, a plurality of livestream videos from a plurality of spectators at an event, present, by the processor via the communication interface, the plurality of livestream videos to the online viewers, allowing the online viewers to manually select which of the plurality of livestream videos they would like to view, receive, by the processor via the communication interface, an indication from each of the online viewers each time that one of the plurality of livestream videos is selected for viewing by an online viewer, tabulate, by the processor, metadata associated with each indication, select, by the processor, a first livestream video from the plurality of livestream videos currently being viewed by the online viewers based on the tabulated metadata, receive, by the processor via the communication interface, a request from a first online viewer to automatically present livestream videos of the event and cause, by the processor, the first video to be presented to the first online viewer on a main viewing window of a first content consumption device associated with the first online viewer.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a block diagram of one embodiment of a system for automatically selecting and presenting livestream videos for presentation to online viewers;

FIG. 2 is a simplified rendering of one embodiment of a video-on-demand presentation presented on a typical display screen of a content consumption device as shown in FIG. 1;

FIG. 3 is a functional block diagram of one embodiment of an online video production server as shown in FIG. 1; and

FIGS. 4A-4C represent a flow diagram of one embodiment of a method for automatically selecting and presenting livestream videos for presentation to online viewers.

### DETAILED DESCRIPTION

Embodiments of the present invention are associated with improvements to video-on-demand production technology. Prior art video-on-demand presentations may provide several livestream videos to online viewers simultaneously, and each online viewer manually selects which of the livestream videos he or she would like to view in a large, main viewing portion of a display of each online viewer's content consumption device (i.e., mobile phone, personal computer, etc.). Embodiments of the present invention allow automatic production of online video-on-demand presentations in real-time, or near-real time, as a plurality of livestream videos is being received by a video production server. For example, a video production server may automatically select and present a livestream video that is currently being watched by the greatest number of online viewers (i.e., most popular), based on a vantage point where each livestream video is being streamed, based on a machine learning model that is trained to recognize videos likely attributes of livestream videos or livestream videos likely to resonate with viewers.

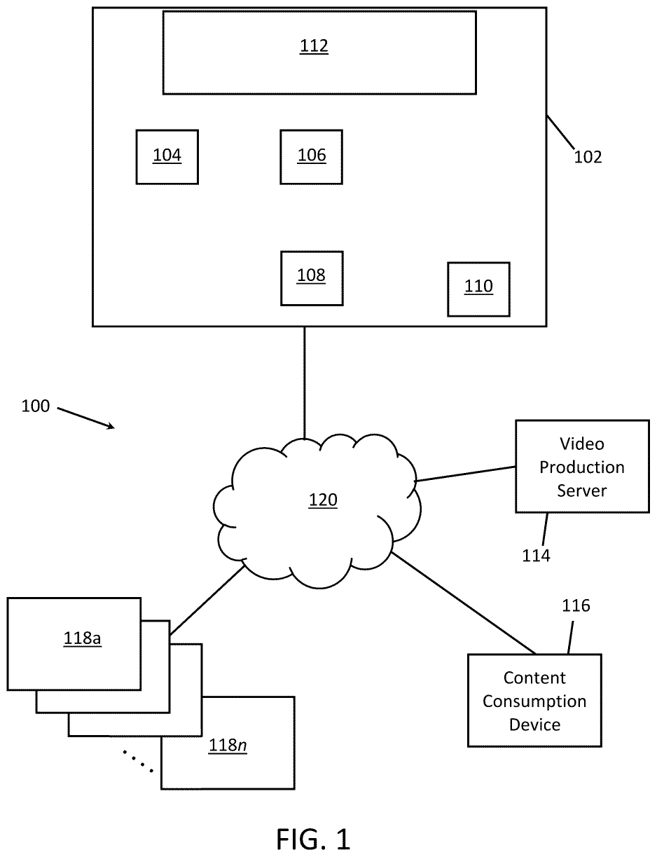

FIG. 1 is a block diagram of a system 100 for automatically selecting and presenting livestream videos and/or, in some embodiments, livestream video clips (i.e., livestream videos that have been stored in a database after each livestream video has ended), for presentation to online viewers. Shown is venue 102, content capture devises 104, 106, 108 and 110, performance area, i.e., “stage” 112, wide-area network 120, video production server 114, content consumption device 116, and a plurality of other content consumption devices 118a-118n.

Venue 102 hosts live events, such as concerts, sporting events, plays, or social events such as parties, weddings, graduations, etc., or some other event typically viewed by a large number of spectators. A “live” event refers to an event where live performers participate in an event, typically in front of live spectators. Such performers may comprise musicians, sports players, actors, partygoers, wedding parties, graduates, etc.

Events may be viewed remotely by “crowdsourcing” livestream videos taken by a plurality of spectators in attendance at an event, each using a “content capture device”, i.e., a smart phone or other smart device, a network-capable video camera, etc. A plurality of content capture devices 104, 106, 108 and 110 is shown in FIG. 1, each located at different locations throughout venue 102, each device capturing a live event from a different vantage point depending on its location.

The content capture devices transmit livestream videos of portions of a live event. For example, each of the content capture devices 104 through 110 in FIG. 1 may each transmit livestream videos to video production server 114 as the event is occurring, providing real-time or near real-time video of the event. Each of these livestream videos may vary in duration from each other, as well as start and stop times, each livestream video particular to a location, or vantage point, of each content capture device inside venue 102. For example, content capture device 110 is situated, in this example, far away from stage 102 and offset from the center of stage 102, to the right, while content capture device 106 is located near stage 102 and center stage. Due to the different locations of each content capture device, livestream video transmitted by each device will be different with respect to a view or vantage point of each device and, typically, audio quality. Thus, each of the content capture devices shown in FIG. 1 may transmit livestream video of the same live event at the same or different times, at the same or different durations, at different vantage points, with differing audio quality depending on location.

Videos are streamed from the content capture devices to video production server 114 either directly, via wide-area network 120, via a website associated with video production server 114, hosted by a webserver associated with video production server 114 (not shown) or via a video streaming app executed by each of the content capture devices.

The website or app may also allow spectators to enter or confirm information about a live event, such as a name of an event (i.e., Lady Gaga concert, Jan and John's wedding, baseball game between the Reds and the Cardinals, etc.), a name of venue 102 (i.e., Dodger Stadium, Del Mar Fairgrounds, etc.), a location of venue 102, a date and time of the event, a seat or section location at venue 102, and/or a predetermined vantage point at venue 102 (such as “pit”, “upper level”, “mezzanine”, etc.). Other information may be recorded as well, such as a name or other identification of the spectator. This information may be referred to herein as “metadata”, used to automatically select livestream videos for presentation to online viewers, as explained later herein.

In some embodiments, each livestream video received by video production server 114 is analyzed by a trained machine learning model to make prediction and/or to determine inferred metadata, such as an event type (i.e., sporting event, concert, wedding, etc.), a vantage point where a video was recorded, the name of a band performing at an event, musician names, themes (i.e., guitar solo, drum solo, all band, lead singer, sports teams and associated players, etc.), etc. In some embodiments, the livestream videos are processed in real-time as they are received by video production server 114 so that they may be automatically selected by video processing server 114 as livestream videos are being presented to online viewers. In some embodiments, livestream videos received by video production serve 114 may be stored as livestream video clips after each livestream video has ended, along with any associated metadata.

As livestream videos are being received by video production server 114, video production server 114 may identify each livestream video as being associated with a particular live event and provide the livestream videos in association with each event to online viewers who have previously expressed interest in viewing each event, respectively. Online viewers may receive the livestream videos via a browser or via a dedicated software application or “app” running on a viewer's fixed or mobile device, i.e. content consumption device 116. Typically, video production server 114 provides a plurality of livestream videos simultaneously on a display screen of content consumption device 116 so that a viewer may select one of the livestream videos for viewing in a main window of the display. In some embodiments, the livestream videos for selection may be shown as video thumbnails.

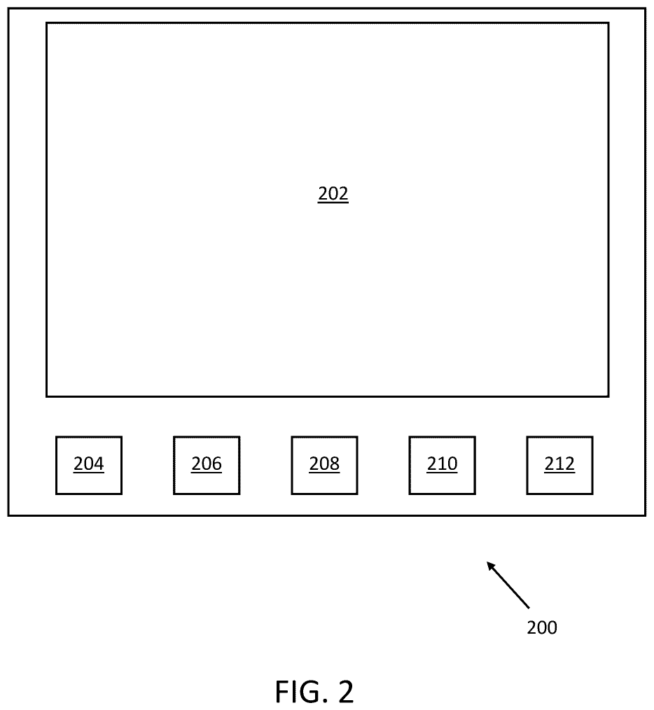

FIG. 2 is a simplified rendering of one embodiment of a video-on-demand presentation presented on a typical display screen 200 of a content consumption device 116. The rendering may be provided by video production server 114, a webserver associated with video production server 114 or a software application executed by content consumption device 116. In this embodiment, the rendering comprises a main viewing window 202 and a plurality of video icons 204-212, each of the video icons displaying one of a plurality of livestream videos streamed by spectators at a live event. In one embodiment, each video icon is dedicated to a particular vantage point at venue 102, and livestream videos received by video production server 114 may be shown as a thumbnail video on one of the video icons, depending on its vantage point. In another embodiment, livestream videos may be assigned to each of the video icons based on one or more factors, such as when a livestream video first started streaming, or, during automatic selection, assigned to the video icons based on popularity of present viewings.

In embodiments where the video icons are each assigned a particular vantage point, an “icon” may comprise a static representation of a particular vantage point at venue 102, such a circle, square, etc. having wording of a vantage point, such as “pit”, “lower level”, etc., or a representative thumbnail image of a particular vantage point. This embodiment may be particularly useful for allowing viewers of the video-on-demand presentation to decide which vantage point to choose for watching a live event in main viewing window 202.

In other embodiments, the number, description and placement of icons in the video-on-demand presentation may vary from what is show in FIG. 2. For example, in FIG. 2, five icons are shown, located beneath main viewing window 202 and labeled as “pit” icon 204 (for viewing videos of the event from a vantage point of someone in the pit area of venue 102), “front row” icon 206 (for viewing videos of the event from a vantage point of someone in a first row of venue 102, or within a predetermined row from the first row, such as the first 3 rows), “lower-level” icon 208 (for viewing videos of the event from a vantage point of someone in a lower level of venue 102, “mid-level” icon 210 (for viewing videos of the event from a vantage point of someone in a middle level of venue 102, and “upper level” icon 208 (for viewing videos of the event from a vantage point of someone in an upper level of venue 102).

As online viewers watch a video-on-demand presentation via their respective content consumption devices 116, they may manually select which livestream video to display in main viewing window 202, typically by clicking on one of the video icons. When a selection is made, an indication may be generated and sent to video production server 114, identifying the selected livestream video. When the viewer stops watching the selected livestream video, or when the livestream video ends, another indication may be generated and sent to video production server 114, indicating such. Video production server 114 may use the indications to tabulate various attributes associated with the chosen livestream videos on an individual basis, an event basis, a category basis (i.e., all baseball videos), such as to tabulate how many times each livestream video is currently being viewed, indicating a popularity of each livestream video, a vantage point associated with each livestream video currently being viewed, an identification of one or more performers, artists, actors, sports stars, band, etc. that appear in each of the livestream videos currently being viewed, etc. The tabulations may be updated as additional livestream videos are viewed by online viewers as an event occurs.

During an event, one or more online viewers of the video-on-demand presentation may request that the video-on-demand presentation be automatically generated, i.e., that livestream videos be selected automatically by video production server 114, a webserver controlled by video production server 114 or an app executed on content consumption device 116. In response, video production server 114, the webserver or the app, automatically selects livestream videos to present to viewers who have requested such automated video stream selection. For example, if ten livestream videos are being received by video production server 114 during a particular event, video production server 114 may select one of the 10 livestream videos that is most popular by online viewers presently viewing the livestream videos of the event, as indicated by the tabulated livestream video attributes.

In one embodiment, an online viewer may additionally submit a request to have video production server 114, the webserver or the app, automatically select videos based on one or more livestream video attributes. For example, an online viewer may request that only livestream videos from certain vantage points, such as the pit area of venue 102, be selected, only videos featuring a certain performer be selected, only videos having a popularity more than a predetermined amount be selected, only videos featuring a particular theme (such as guitar solo, drum solo, artist close-up, etc.), only videos streamed by or more particular people (i.e., influencers, people known to provide desirable video), only livestream videos, livestream videos plus livestream video clips, etc. In response, video production server 114, the webserver or the app, may automatically select livestream videos currently being streamed based on the request.

After automatically selecting one or more of the livestream videos, video production server 114, webserver or the app, may cause the selected livestream video to be automatically displayed in the main viewing window 102 of one or more content consumption devices 116. After the selected livestream video ends, or at some other point during presentation of the selected livestream video, video production server 114, the webserver or the app, may automatically select another livestream video based on the tabulated attributes and cause it to be displayed in the main viewing window 102 of one or more content consumption devices 116. In one embodiment, automatic selection of livestream videos may be determined on an event basis, i.e., where any viewer that has requested automatic selection of livestream videos of a particular event will all receive the same, automated selection at substantially the same time. In another embodiment, automatic selection of livestream videos is performed on an individual basis, based on tabulated attributes stored for each online viewer and/or requests from each online viewer.

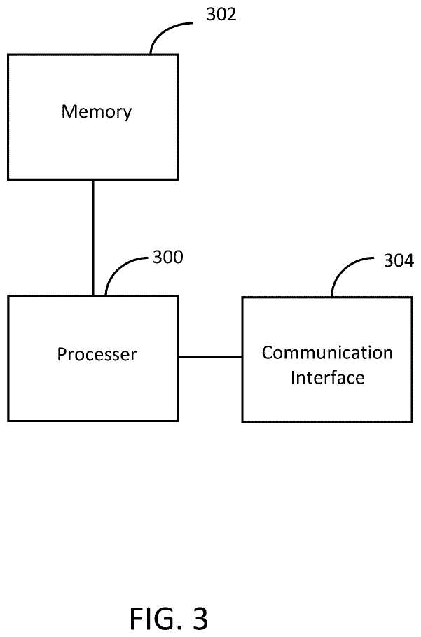

FIG. 3 is a functional block diagram of one embodiment of video production server 114, showing processor 300, memory 302, and communication interface 304. It should be understood that not all of the functional blocks shown in FIG. 3 are required for operation of video production server 114 in some embodiments, that the functional blocks may be connected to one another in a variety of ways, and that not all functional blocks necessary for operation of video production server 114 are shown (such as a power supply), for purposes of clarity.

Processor 300 is configured to provide general operation of video production server 114 by executing processor-executable instructions stored in memory 302, for example, executable code. Processor 300 may comprise one of a variety of microprocessors, microcomputers, microcontrollers, SoCs, modules and/or ASICs. Processor 300 may be selected based on a variety of factors, including power-consumption, size, and cost.

Memory 302 is coupled to processor 300 and comprises one or more information storage devices, such as RAM, ROM, flash memory, or some other type of electronic, optical, or mechanical memory device(s). Memory 302 is used to store processor-executable instructions for operation of video production server 114 as well as any information used by processor 300, such as tabulations of livestream video attributes, event information including time and location of each event, livestream video clips, and other information used by the various functionalities of video production server 114. It should be understood that memory 302 is non-transitory, i.e., it excludes propagating signals, and that memory 302 could be incorporated into processor 300, for example, when memory processor 300 is an SoC. It should also be understood that once the processor-executable instructions are loaded into memory 302 and are executed by processor 300, video production server 114 may become a specialized computer for automatically selecting and presenting livestream videos to online viewers. It should also be understood that the processor-executable instructions improve conventional video creation and production technology, because it allows livestream videos to be automatically selected based on various tabulated attributes as a plurality of livestream videos are being viewed by online viewers.

In some embodiments, memory 302 may additionally store one or more trained machine learning models used to predict attributes of incoming livestream videos and/or automatically select which of a plurality of incoming livestream videos may be most desirable for online viewers to watch.

Communication interface 304 is coupled to processor 300, comprising well-known circuitry for allowing video production server 114 to communicate with content capture devices and content consumption devices via a wide-area network 120.

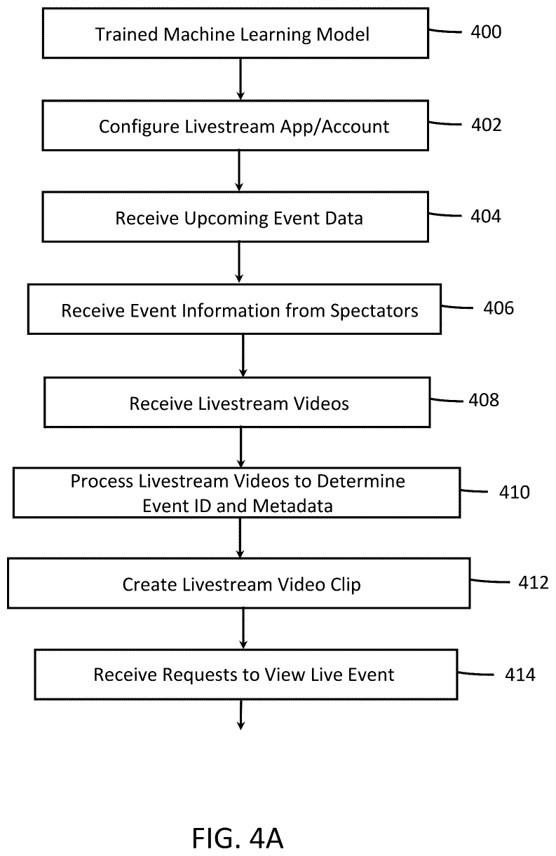

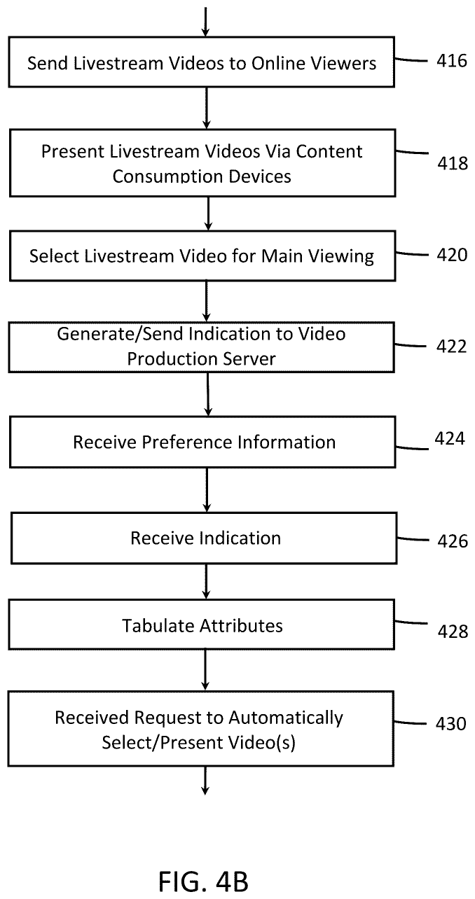

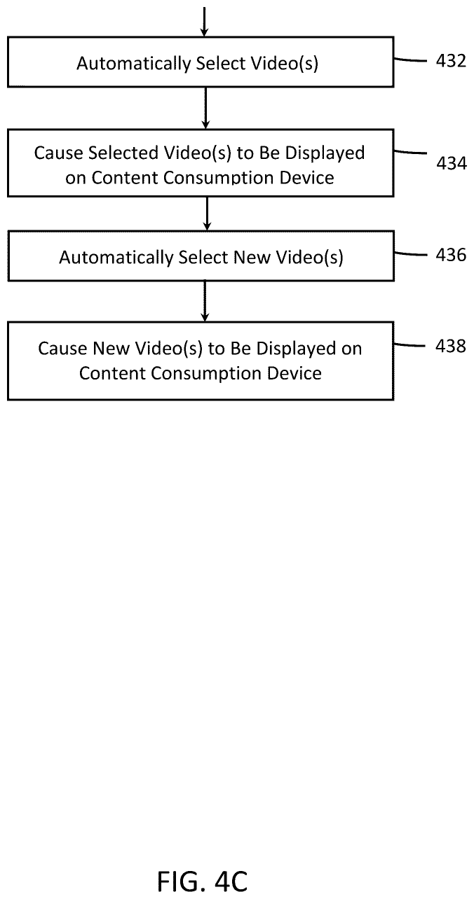

FIGS. 4A-4C represent a flow diagram illustrating one embodiment of a method for automatically selecting and presenting livestream videos to online viewers. It should be understood that in some embodiments, not all of the method steps shown in FIGS. 4A-4C are performed and that the order in which the steps are performed may be different in other embodiments. The method will be described in connection with FIGS. 1-3, referring to a particular concert occurring live at venue 102.

At step 400, in one embodiment, a machine learning model is trained to identify particular attributes associated with livestream videos received by video production server 114 from content capture devices 118a-n. During training, many hundreds or thousands of digital videos of different events, recorded at different vantage points, are provided to an untrained machine learning model. Each video typically comprises metadata that describes various attributes of each video, such as an identification of an event type (concert, sporting event, wedding, etc.), a genre (in the case of a concert), a location where each video was recorded, the name of a venue where each video was recorded, the name of a song, one or more names of one or more performers shown in a video (such as the name of an artist, a band, a sporting event, a team name, a player name, etc.), a vantage point, a lighting level, a video quality, a video resolution, an audio quality, an identification of a content capture device 118 that recorded the video, and identification of the person providing the livestream video, etc. These videos and associated metadata may be referred to as “training data”. The machine learning model analyzes the training data and changes various weights assigned to each node of the machine learning model based on the training data. The result is a trained machine learning model that can analyze future livestream videos to predict various attributes of each livestream video and/or a desirability of each livestream video. After training, the trained model may analyze livestream videos and generate one or more

In a related embodiment, the machine learning model (or a different machine learning model) is trained to predict an overall desirability metric associated with livestream videos, based on such attributes as proximity to a stage, vantage point (such as center loge), sound quality, video quality, framing, length of video, crowd noise, and/or other factors. As above, many hundreds or thousands of digital videos of different events, and associated metadata, are provided to the machine learning model for training purposes, each training video associated with a subjective desirability rank, score or metric indicating how desirable each video is for watching by online viewers, as viewed by a training technician. After training, the trained machine learning model may analyze livestream videos to predict one or more attributes of each livestream video, and/or to predict a desirability score, rank or metric of each livestream video. In one embodiment, the trained machine learning model may additionally provide a probability that a livestream video is desirable, for example, on a scale between 0 and 1.

At step 402, a livestream video recording and streaming app, i.e., the livestream app discussed earlier herein and executed by each of the content capture devices 104-112, is configured by each spectator of a live event. Typically, each spectator creates an account with video production server 114, or another server associated with video production server 114, and provides account information such as a spectator name, address, password, credit card information, make and/or model of the spectator's content capture device, etc. In another embodiment, where an app is not used and livestream videos are streamed directly to a webserver via a web browser of a content capture device 118, a spectator may provide account and event information to video production server 114 using a browser interface.

At step 404, processor 300 may receive upcoming event information associated with the event prior to the start of the event and store the event information in memory 302. A variety of online services may provide this information. Typically, the event information comprises an identification of an event, such as a name of an event (i.e., Lady Gaga concert, Jan and John's wedding, baseball game between the Reds and the Cardinals, etc.), a name of a venue where each event will be held (i.e., Dodger Stadium, Del Mar Fairgrounds, etc.), seating or section information of the each venue (i.e., a ranking of seats based on a vantage point of a stage, a listing of sections, such as “pit”, “upper level”, “mezzanine”, etc.), a date, an expected start time, an expected end time and/or an expected duration of each event, etc. Processor 300 may use the event information to associate livestream videos and to live events.

At step 406, in one embodiment, users of content capture devices 118a-n at the event may provide event information to video production server 114 in order to “pre-register” with the event. For example, a spectator before or during a concert may login to the spectator's account and enter information regarding the concert, such as a name of the concert, a venue name, a venue address, etc. so that video production server 114 can identify the event where the spectator is present.

At step 408, during the live event, processor 300, via communication interface 304 receives livestream videos from content capture devices 118a-n located at venue 102 (as well as other livestream videos that may be received from content capture devices worldwide at different live events) via wide-area network 120. Processor 300 may also receive metadata associated with each livestream video, the metadata providing information associated with each livestream video, such as the name of a spectator who is providing a livestream video, a content capture ID (i.e., an IMEI), an event name, a venue name, a venue location or address, a date and time that the livestream video was taken (i.e., a start time and date, an end time and date, etc.), a vantage point of the spectator in venue 102, a section number, row number, seat number, an identification of one or more performers in the event, a theme of each livestream video, etc.

At step 410, each of the livestream videos received by processor 300 is processed to identify an event from which each livestream video is being streamed and to extract and store the metadata associated with each livestream video in memory 302.

At step 412, processor 300 may create livestream video clips from the livestream videos (i.e., a video clip created from a livestream video) in memory 302 after each livestream video has ended. Each stored livestream video clip may be stored in association with its respective metadata.

At step 414, processor 300 may receive requests from a plurality of online viewers via wide-area network 120 and communication interface 304 to view the event. Processor 300 may store the requests in association with each online viewer, respectively.

At step 416, processor 300 may cause livestream videos currently being received from spectators at the event to any online viewer who requested to view the event. The livestream videos may be presented as a video-on-demand presentation, the same or similar as shown in FIG. 2, or in some other arrangement.

At step 418, the livestream videos of the event are simultaneously presented to each online viewer in real-time, or near-real time, via display 200 of each viewer's content consumption device 116, either by video production server 114, a related webserver or by a software application running on a content consumption device.

At step 420, each of the online viewers may select one of the livestream videos to view in a main viewing window 202 of the video-on-demand presentation, typically by clicking on one of the icons 204-212. As a result, the selected livestream video is displayed typically in a larger format in main viewing window 202.

At step 422, each of the content consumption devices 116 may generate and send an indication to video production server 114, indicating which livestream video was selected for viewing in main viewing window 202. In one embodiment, after watching a livestream video, whether in totality or partially, another indication may be sent to video production server 114, comprising a time indicative of how long a particular viewer watched a particular livestream video or whether a particular livestream video was watched to conclusion.

At step 424, in one embodiment, processor 300 may receive preferences from the online viewers, each preference comprising an indication of one or more desired attributes of livestream videos that each online viewer would like to receive. For example, one online viewer may provide a preference indicating that the online viewer prefers to receive the most popular livestream video currently being viewed by other online viewers (or the top three most-popular livestream videos), another online viewer may provide a preference indicating that the online viewer prefers to view events no further away than a pit area of venue 102 (i.e., from a plurality of vantage points so long as each vantage points is no further away than the pit area from stage 102), while still another online viewer may provide a preference indicating that the online viewer prefers to receive livestream videos featuring any guitar solo, or featuring an entire band onstage, or featuring a particular band member.

At step 426, processor 300 of video production server 114 receives the indications from each online viewer who selected one of the livestream videos currently being streamed and/or, in another embodiment, receives one or more preferences from one or more of the online viewers.

At step 428, processor 300 tabulates attributes associated with livestream videos identified by any indications that are received as each livestream video is being received by video production server 114. Tabulation may be performed for viewers of the event as a whole, or on an individual basis. For example, as each indication is received, processor 300 may identify a particular livestream video selected by a respective online viewer and increment a counter that tracks how many times a particular livestream video is being viewed by online viewers of the event. In one embodiment, tabulations may be additionally updated when an online viewer watches a livestream video clip of the event (separate counters may be used to tabulate live views versus stored views). Processor 300 may also increment a separate counter associated with each of the online viewers, respectively, that tracks attributes of livestream videos viewed by each online viewer. In this embodiment, the tabulated attributes of livestream videos viewed by each online viewer may be used to more particularly select relevant future livestream videos, and/or stored video clips, for presentation to each online viewer based on each livestream viewer's tabulated attributes.

In one embodiment, where machine learning has been used to identify particular attributes of livestream videos (i.e., identification of an event, identification of a particular event, identification of a band, identification of a performer, identification of a vantage point, identify a sport, etc.), or a predicted desirability metric, processor 300 may increment other counters, each associated with a particular attribute, depending on one or more predictions provided by the trained machine learning model. For example, if the trained machine learning model has predicted that a livestream video contains a view of a particular guitar player during a guitar solo provided from a particular vantage point at the event, played during a particular song, a counter for each of the particular guitar player, vantage point, guitar solo, and particular song may be incremented. This may occur for online viewers as a whole or on an individual basis. As time goes on, multiple counters are incremented as livestream videos are received with different attributes, to be used in automatic selection by processor 300 as described below. As another example, processor 300 may determine, via the trained machine learning model, or a second trained machine learning model, a most-desirable livestream video from the plurality of livestream videos currently being received by video production server 114, based on one or more attributes of the plurality of livestream videos. In one embodiment, processor 300 may rank the plurality of livestream videos in association with each other to provide a listing of a most-desirable livestream video to a least-desirable livestream video. As livestream videos end and/or new livestream videos are received, processor 300 may determine a new most-desirable livestream video from the plurality of livestream videos being received at any given time.

At step 430, processor 300 may receive a request from a first online viewer of the event to automatically select livestream videos for viewing in main viewing window 202, rather than having to manually select livestream videos for viewing. In one embodiment, the request may comprise metadata, such as an identification of the online viewer and/or an identification of content consumption device 116. The metadata may additionally comprise preference information, indicating one or more attributes of livestream videos the first online viewer would like to receive, i.e., an identification of one or more desired vantage points, one or more desired performers, one or more song portions/themes (i.e., guitar solo, drum solo, chorus, etc.), and identification of one or more desired persons who regularly provide content (i.e., influencers, persons known to provide quality content, etc.), or some other attribute associated with livestream videos the first online viewer would like to receive.

At step 432, processor 300 automatically selects one or more livestream videos from the plurality of livestream videos currently being received by video production server 114 for prominent display to the first online viewer. Automatic selection may occur as requests are received, continuously, at predetermined times or events, etc.

In one embodiment, processor 300 selects one of the livestream videos currently being provided to online viewers of the event that has been viewed the greatest number of times, in accordance with an associated counter. In this embodiment, processor 300 selects a single livestream video that is currently being viewed by the greatest number of online viewers of the event. In another embodiment, processor 300 may rank the livestream videos being presented to the online viewers based on the number of times that each of the livestream videos has been selected for viewing by each online viewer. In this embodiment, processor 300 may select a predetermined number of top-ranked livestream videos for presentation to the first online viewer, such as the top three, or the top five, most-popular livestream videos. Processor 300 may select one of the plurality of top-ranked livestream videos for presentation in main viewing window 202, such as the top-ranked livestream video while presenting the other livestream videos in a smaller format on display screen 200, such as in a plurality of video thumbnails.

In one embodiment, processor 300 may, alternatively or in addition to selecting only livestream videos, include livestream video clips stored in memory 302 in the automatic selection process. In this embodiment, livestream video clips are created and stored in memory 302 after each livestream video ends. Metadata may also be stored in association with each livestream video clip, such as any tabulated attributes associated with an associated livestream video while the associated livestream video was being livestream to online viewers. As above, processor 300 may select one or more livestream video clips for automatic presentation to the first online viewer based on the tabulated attributes.

In one embodiment, alternatively or in addition to the above, processor 300 may automatically select one or more livestream videos and/or livestream video clips based on either metadata received with the request, or from receipt of preference indicators provided by the first online viewer. For example, the first online viewer may have sent a request for automatic livestream video presentations and, particularly, of any livestream videos taken at a particular vantage point, or any livestream videos taken at a particular vantage point that include a view of a bass player, etc. Processor 300 selects one or more livestream videos currently being provided to online viewers based on the counter values of each tabulated attribute associated with the livestream videos currently being streamed.

In a related embodiment, as livestream videos are received by video production server 114, they may be processed by the one or more trained machine learning models to predict various attributes associated with each livestream video, or to determine a desirability rating, score or metric. For example, the trained machine learning model may predict an event type (i.e., a particular sporting event, a concert, a play, a wedding, etc.), one or more particular performers (i.e., an actor, sports player, guitar player, singer, etc.), a vantage point where each livestream video is being streamed, a song portion/theme (i.e., guitar solo, drum solo, chorus, etc.), an identification of the person currently providing each livestream video, a desirability metric or some other attribute. The predictions may be stored in memory 302 in association with each livestream video as each of the livestream videos is being provided to the online viewers of the event. When a request is received from an online viewer to automatically receive livestream videos having certain attributes, processor 300 may compare the request to the attributes stored in memory 302 to identify livestream videos currently being provided to online viewers matching one or more of the attributes.

In one embodiment, automatic selection of livestream videos may occur based on two or more factors. For example, in an embodiment using one or more trained machine learning models, a desirability metric may be predicted for each livestream video currently being received by video production server 114, and if none of the livestream videos exceeds a predetermined desirability threshold, indicating that nothing of particular interest is occurring in any of the livestream videos (i.e., no guitar solos, no pyrotechnics, no persons of interest, etc.), then processor 300 may automatically select one of the livestream videos for automatic presentation to one or more online viewers based on some other factor, such as the video being watched by the most number of online viewers, a video recorded at a most-desired vantage point, etc. However, when at least one of the livestream videos currently being received exceeds the predetermined desirability metric threshold, then at least one of said livestream videos may be automatically selected and presented to online viewers.

At step 434, processor 300 may cause the selected livestream video or livestream video clip to be displayed in main viewing window 202. In an embodiment where a plurality of livestream videos and/or livestream video clips is automatically selected by processor 300, processor 300 may select one of the livestream videos or livestream video clips for presentation in main viewing window 202, and cause one or more of the other selected livestream videos to be displayed in other windows of display 200, for example, as video icons in video icons 204-212.

At step 436, processor 300 may automatically select a new livestream video or livestream video clip for presentation in main viewing window 202 of a content consumption device 116, by selecting a second most-popular livestream video currently being viewed (or livestream video clip), or using some other attribute. For example, when a first selected livestream video or livestream video clip ends, or a request is received from an online viewer to automatically provide a different livestream video, processor 300 may select the second most-popular livestream video to be automatically presented to the first online viewer, or another livestream video based on another attribute.

At step 438, processor 300 causes the next automatically-selected livestream video or livestream video clip to be displayed in main viewing window 202 of a content consumption device 116.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a spectator terminal. In the alternative, the processor and the storage medium may reside as discrete components.

Accordingly, an embodiment of the invention may comprise a computer-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method, performed by a video production server, for automatically for automatically selecting and presenting livestream videos to online viewers, comprising:
receiving a plurality of simultaneous livestream videos from a plurality of spectators at an event;
presenting the plurality of livestream videos to the online viewers simultaneously, allowing the online viewers to manually select which of the livestream videos they would like to view;
receiving an indication from each of the online viewers each time that one of the plurality of livestream videos is selected for viewing by an online viewer;
tabulating metadata associated with each indication;
selecting a first livestream video from the plurality of livestream videos currently being viewed by the online viewers based on the tabulated metadata;
receiving a request from a first online viewer to automatically present livestream videos of the event; and
causing the first video to be displayed to the first online viewer on a main viewing window of a first content consumption device associated with the first online viewer.

2. The method of claim 1, wherein the metadata of each indication comprises an identification of one of the plurality of livestream videos, wherein selecting the first livestream video comprises:
based on the metadata, determining how many online viewers are watching each of the plurality of livestream videos; and
selecting the first video when the first video is being watched by more online viewers than any other of the plurality of livestream videos.

3. The method of claim 2, further comprising:
based on the metadata, determining when a second video is being watched by more online viewers than any other of the plurality of livestream videos, including the first video; and
in response, causing the second livestream video to be displayed to the first online viewer on the main viewing window of the first content consumption device.

4. The method of claim 1, further comprising:
determine how many online viewers are watching each of the plurality of livestream videos, respectively;
ranking the plurality of livestream videos based on the number of online viewers watching each of the plurality of livestream videos, respectively;
causing the first livestream video to be displayed to the first online viewer on the main viewing window of the first content consumption device when the first video has been ranked as a top-ranked livestream video; and
causing at least a second-ranked livestream video to be displayed to the first online viewer in a second viewing window of the first content consumption device while the first livestream video is being displayed in the main viewing window of the first content consumption device.

5. The method of claim 1, wherein tabulating the metadata comprises storing a number of times that each of the plurality of livestream videos has been watched over time, wherein selecting the first livestream video comprises:
selecting the first livestream video when the first livestream video has been watched the most over time.

6. The method of claim 1, wherein the metadata comprises a user preference for viewing the plurality of livestream videos;
comparing the user preference to the tabulated metadata to determine when at least a partial match is found;
wherein selecting the first livestream video from the plurality of livestream videos currently being viewed comprises:
selecting the first livestream video for presentation to the first online viewer when at least a partial match is found between the user preference and tabulated metadata associated with the first livestream video.

7. The method of claim 6, where the user preference is selected from the group consisting of a preferred vantage point and a focus on particular performer in the event.

8. The method of claim 1, further comprising:
storing tabulated metadata in association associated with plurality of livestream videos selected for viewing by a second online viewer;
receiving a second request from the second online viewer to automatically present livestream videos of the event;
evaluating additional livestream videos received after receiving the second request to determine additional metadata associated with each of the additional livestream videos;
comparing the additional metadata to the tabulated metadata associated with the second online viewer;
selecting a second livestream video for automatic presentation to the second online viewer when at least some of the tabulated metadata associated with the second online viewer matches additional metadata associated with the second livestream video;
and causing the second livestream video to be displayed in a second main viewing window of a second content consumption device associated with the second viewer.

9. The method of claim 8, wherein the tabulated metadata comprises a number of times that the second online viewer previously watched livestream videos taken from a plurality of potential vantage points, wherein selecting the second livestream video comprises:
determining a vantage point associated with each of the plurality of livestream videos;
comparing each of the vantage points of each of the plurality of livestream videos to the vantage point most viewed by the second online viewer; and
selecting the second livestream video from the plurality of livestream videos when one of the plurality of livestream videos was recorded at the vantage point most viewed by the second online viewer.

10. The method of claim 1, further comprising:
training a machine learning model to identify desirable video attributes of livestream videos, resulting in a trained machine learning model;
applying the plurality of livestream videos to the trained machine learning model;
ranking each of the plurality of livestream videos in accordance with at least one video desirability attribute; and
selecting the first livestream video from the plurality of livestream videos when the first livestream video is ranked the highest of the plurality of livestream videos.

11. A video production server for automatically selecting and presenting livestream videos to online viewers, comprising:
a communication interface;
a non-transitory memory for storing processor-executable instructions; and
a processor, coupled to the communication interface and the memory for executing the processor-executable instructions that causes the video production server to:
receive, by the processor via the communication interface, a plurality of livestream videos from spectators at an event;
present, by the processor via the communication interface, the plurality of livestream videos to the online viewers, allowing the online viewers to manually select which of the plurality of livestream videos they would like to view;
receive, by the processor via the communication interface, an indication from each of the online viewers each time that one of the plurality of livestream videos is selected for viewing by an online viewer;
tabulate, by the processor, metadata associated with each indication;
select, by the processor, a first livestream video from the plurality of livestream videos currently being viewed by the online viewers based on the tabulated metadata;
receive, by the processor via the communication interface, a request from a first online viewer to automatically present livestream videos of the event; and
causing, by the processor, the first livestream video to be presented to the first online viewer on a main viewing window of a first content consumption device associated with the first online viewer.

12. The video production server of claim 11, wherein the metadata of each indication comprises an identification of one of the plurality of livestream videos, wherein the processor-executable instructions that causes the video production server to select the first livestream video comprises instructions that causes the video production server to:
based on the metadata, determine, by the processor, how many online viewers are watching each of the plurality of livestream videos; and
select, by the processor, the first video when the first video is being watched by more online viewers than any other of the plurality of livestream videos.

13. The video production server of claim 11, wherein the processor-executable instructions comprise further instructions that causes the video production server to:
based on the metadata, determine, by the processor, when a second video is being watched by more online viewers than any other of the plurality of livestream videos, including the first video; and
in response, cause, by the processor, the second livestream video to be displayed to the first online viewer on the main viewing window of the first content consumption device.

14. The video production server of claim 11, wherein the processor-executable instructions comprise further instructions that causes the video production server to:
determine, by the processor, how many online viewers are watching each of the plurality of livestream videos, respectively;
rank, by the processor, the plurality of livestream videos based on the number of online viewers watching each of the plurality of livestream videos, respectively;
cause, by the processor, the first livestream video to be displayed to the first online viewer on the main viewing window of the first content consumption device when the first video has been ranked as a top-ranked livestream video; and
cause, by the processor, at least a second-ranked livestream video to be displayed to the first online viewer in a second viewing window of the first content consumption device while the first livestream video is being displayed in the main viewing window of the first content consumption device.

15. The video production server of claim 11, wherein the processor-executable instructions that cause the video production server to tabulate the metadata comprise instructions for the processor to determine how long each livestream video has been watched by each of the online viewers, wherein the processor-executable instructions that cause the video production server to identify the first livestream video comprises instructions that cause the video production server to identify which of the plurality of livestream videos has been watched the longest.

16. The video production server of claim 11, wherein the processor-executable instructions that cause the video production server to tabulate the metadata comprises instructions that cause the processor to store in the memory a number of times that each of the plurality of livestream videos has been watched over time, wherein the processor-executable instructions that cause the video production server to select the first livestream video comprise instructions that causes the video production server to:
select, by the processor, the first livestream video when the first livestream video has been watched the most over time.

17. The video production server of claim 11, wherein the metadata comprises a user preference for viewing the plurality of livestream videos, and ;
comparing the user preference to the tabulated metadata to determine when at least a partial match is found;
wherein selecting the first livestream video from the plurality of livestream videos currently being viewed comprises:
selecting the first livestream video for presentation to the first online viewer when at least a partial match is found between the user preference and tabulated metadata associated with the first livestream video.

18. The video production server of claim 17, where the user preference is selected from the group consisting of a preferred vantage point and a focus on particular performer in the event.

19. The video production server of claim 11, wherein the processor-executable instructions comprise further instructions that causes the video production server to:
storing tabulated metadata in association associated with livestream videos selected for viewing by a second online viewer;
receiving a second request from the second online viewer to automatically present livestream videos of the event;
evaluating additional livestream videos received after receiving the second request to determine additional metadata associated with each of the additional livestream videos;
comparing the additional metadata to the tabulated metadata associated with the second online viewer;
selecting a second livestream video for automatic presentation to the second online viewer when at least some of the tabulated metadata associated with the second online viewer matches additional metadata associated with the second livestream video;
and causing the second livestream video to be displayed in a second main viewing window of a second content consumption device associated with the second viewer.

20. The video production server of claim 19, wherein the tabulated metadata comprises a number of times that the second online viewer previously watched livestream videos taken from a plurality of potential vantage points, wherein selecting the second livestream video comprises:
determining a vantage point associated with each of the plurality of livestream videos;
comparing each of the vantage points of each of the plurality of livestream videos to the vantage point most viewed by the second online viewer; and
selecting the second livestream video from the plurality of livestream videos when one of the plurality of livestream videos was recorded at the vantage point most viewed by the second online viewer.

21. The video production server of claim 11, wherein the processor-executable instructions comprise further instructions that causes the video production server to:
training a machine learning model to identify desirable video attributes of livestream videos, resulting in a trained machine learning model;
applying the plurality of livestream videos to the trained machine learning model;
ranking each of the plurality of livestream videos in accordance with at least one video desirability attribute; and
selecting the first livestream video from the plurality of livestream videos when the first livestream video is ranked the highest of the plurality of livestream videos.

22. The video production server of claim 21, wherein training the machine learning model comprises:
storing the plurality of livestream videos as a plurality of livestream video clips;
determining a viewing frequency of each of the plurality of livestream video clips; and
providing the stored plurality of livestream videos and an indication of the viewing frequency of each of the plurality of livestream videos, respectfully.
